(19) United States
(12) Patent Application Publication
(10) Pub. No.: US 2003/0056411 A1
(43) Pub. Date: Mar. 27, 2003

(54) Interactive showcase and display wall

(76) Inventor: Jos Wijtenburg, Ettringen (DE)

Correspondence Address: GROSSMAN, TUCKER, PERREAULT & PFLEGER, PLLC, 55 South Commercial Street, Manchester, NH, 03101, US

(21) Appl. No.: 10/193,691

(22) Filed: Jul. 11, 2002

(30) Foreign Application Priority Data
Jul. 11, 2001 (DE) 101 33 096.0

(51) Int. Cl. G09F 1/00; G09F 3/04

(52) U.S. Cl. 40/446; 40/447

(57) ABSTRACT

A showcase for bills, placards and like affords only limited information if it is used as a way of catching the eye. To offer a person viewing same more information about for example products being promoted, the showcase of the invention has a display device supplied with digital picture or video signals by an internal computer controllable by a person viewing the showcase. The display device is visible through a window in the showcase wall and the bill, placard or the like. The showcase can be used in advertising for products and services.

### FIELD OF THE INVENTION

The invention concerns a showcase for bills, posters, placards and the like, for example for advertising purposes. The invention further concerns a display wall for supporting bills, posters, placards and the like.

### BACKGROUND OF THE INVENTION

In order to provide for example advertising for products or services, bills, placards, posters and other suitable information carriers of a flat configuration can be mounted on a display wall of a showcase. The showcase can be mounted for example on a wall suspended therefrom or can possibly be erected in a freestanding position in space on a suitable support stand or supporting structure. The carrier for the information to be provided for such purposes, in graphic or pictorial form, can be for example paper or transparent film. The display wall can also comprise a transparent material. Back-lighting of the information carrier has a particular effect in terms of drawing the attention of a person viewing the display wall, to the information carrier thereon.

If such showcases are to have an eye-catching effect, the information contained in the representation thereon is naturally limited as an overload of information in that situation can have the effect of causing confusion on the part of the person viewing it and precisely does not have the effect of attracting attention readily. On the other hand however there is a wish to be able to afford a person viewing the information, once the attention of that person has been attracted, details about the products or services which are being advertised thereby. Previous designs of showcases afford here at best the possibility of obtaining further information by applying to specified reference addresses. It will be appreciated however that this requires further effort on the part of a potentially interested person who therefore can possibly not be converted from a person showing interest into an actual customer.

### SUMMARY OF THE INVENTION

An object of the present invention is to provide a showcase for bills, posters, placards and the like, for example for advertising purposes, with which a person viewing same can obtain additional information over and above information contained on the displayed information carrier.

Another object of the present invention is to provide a showcase for an information carrier, such that it can afford basic items of information but under interactive control from a person viewing the showcase can provide additional more detailed information using a simple operating procedure.

Yet another object of the present invention is to provide a display wall for displaying an information carrier, which is of a simple design configuration but which affords versatility of presentation of information to a person viewing same.

In accordance with the principles of the present invention the foregoing and other objects are attained by a showcase comprising at least one show wall or display wall having a window through which a display device for visual signals is visible, and a signal source for producing said signals and controllable by a person viewing the showcase.

The visual signals can be digital picture signals or digital video signals.

Further in accordance with the invention the foregoing and other objects are attained by a display wall for an information carrier, for example for bills, posters, placards and the like, comprising an image surface and, in said surface, a display device for digital visual signals such as picture or video signals, adapted to be controllable by a person viewing same in an interactive mode.

As will be seen from an embodiment of the invention as described in greater detail hereinafter, the showcase can provide information on an information carrier such as a bill, poster and the like on the front surface thereof, while additional items of information can be produced on a display device which is visible through the window in the display wall of the showcase, the display wall being the part thereof which exerts the initial eye-catching effect. The display device displays digital visual signals such as picture or video signals produced by the signal source which is interactively controllable by the person viewing the showcase. The signal source can be for example a computer producing the picture or video signals from information which it calls up from a suitable memory. It will be noted however that the signal source may alternatively comprise units which directly transmit or store picture or video signals such as television tuners, DVD playback units, or video storage and recording devices.

For example, the display device can firstly display a menu which explains the control options to the person viewing the arrangement. Those options may for example concern various products or various groups of information such as technical data or views of the product in question. The menu setup may also involve a plurality of stages or submenus, when there is a relatively large amount of information on offer.

An information carrier such as a bill, poster or the like which is displayed on the display wall of the showcase according to the invention has a cut-out which is congruent with the outline of the window. As a result the display device is visible in the window and is not covered over by the information carrier. Preferably the display surface of the display device is in or in the proximity of the viewing plane of the information carrier such as the poster in order to avoid troublesome parallax effects.

The display device can be any suitable device which makes it possible for digital visual signals such as picture or video signals to be rendered visible thereon. Suitable devices are monochrome or color monitors in the form for example of cathode ray tubes, liquid crystal display devices, referred to for the sake of brevity as LCDs, plasma display devices and vacuum fluorescence displays, also referred to as fluorescent tube displays or FTDs.

The showcase is provided with means to enable the person viewing same to implement control of the computer. They can involve for example switches or keys. In a preferred embodiment the display device can be in the form of a touch-sensitive picture screen, also referred to for brevity as a touch screen, on which it is possible to display a menu comprising a plurality of control commands which can be called up by the person viewing same, by suitably touching the screen. Representation of the control commands can be in alphanumeric form or by means of images or icons or parts of an overall representation.

In a preferred embodiment of the invention the showcase also has means for generating and/or reproducing acoustic signals. The means for producing such signals can be for example software programs for the computer or playback devices for audio carriers such as magnetic tape cassettes and CDs which can be controlled by the computer. Reproduction of the signals can be effected by means of a suitable loudspeaker arrangement.

In a preferred feature the display wall of the showcase according to the invention has a removable holding frame which extends around the outer edge thereof. The holding frame makes it possible for the displayed information carrier such as a bill, poster or the like to be clamped between the frame and the display wall so that it is interchangeably fixed in position there. In that case a transparent protective sheet which covers the information carrier, for example comprising a plastic film, can also be fixed in position. If the protective sheet by virtue of its nature prevents operation of the touch screen, it also has to be provided with a cut-out which is congruent with the window in the display wall.

Handling of the removable holding frame is made easier if it is mounted pivotably to a side edge of the display wall. The pivotal mounting can involve a hinge arrangement. If the holding frame is mounted to the upper edge of the display wall and can thus be pivoted upwardly, it can advantageously be held in the raised position by one or more gas springs.

In a preferred feature the display wall of the showcase itself is also removable in order to permit access to the components which are disposed in its interior.

In a particularly preferred feature the display wall is also mounted pivotably to a side edge. The display wall and the frame thereof can be mounted to the same side edge or to oppositely disposed edges, or to edges which meet at a corner of the showcase.

In a preferred feature of the invention the showcase is provided with means which permit back-lighting of the information carrier displayed on the showcase. That can be effected for example by lamps disposed in the interior of the showcase, such as incandescent lamps or fluorescent tubes. In that case the display wall of the showcase comprises a translucent material such as glass or acrylic glass, in which respect a light-guiding glass or such a plastic material, for example a special light-guiding acrylic glass, is particularly preferred, and can have a frame comprising for example metal, wood or plastic material. In the interests of providing for uniform illumination lamps are desirably arranged in the edge region, where they are covered by the holding frame which in this case is opaque, or possibly by the frame of the display wall. The lamps can be fixed for example to the rear side of the frame or to the inside wall of the showcase.

Preferably the showcase according to the invention has storage means for supplying the computer with information which it requires to produce the digital picture or video signals. Such storage means can be for example non-volatile memory means such as hard disks, flash memories, possibly on cards, floppy disk, CDROM or DVD drives or also volatile memories which for example permit repetition of an information sequence controlled by the person viewing the showcase.

In a preferred feature the computer can obtain the information required to produce the signals wirelessly or by way of a line from an external information source. Wireless transmission can be effected for example by way of satellite or terrestrial radio, by infrared communication or by means of mobile communication. The Internet can be used as a data source.

In a preferred feature the window occupies a proportion of between about 5 and 25% of the surface area of the display wall.

In an advantageous feature of the invention the showcase can also have further means for supporting interactive operation by the person viewing it. These are for example means for identification of the person viewing it such as magnetic card, smart card or bar code readers, and devices for fingerprint and/or facial recognition. That makes it possible to provide information selectively for given known customers or for unknown persons viewing the showcase respectively.

Preferably the showcase according to the invention is provided with a motion sensor. In that way for example it is possible to display on the display device an image corresponding to the part of the information carrier such as a bill or placard, which is congruent with the window, so that the overall visual impression afforded by the showcase is not adversely affected from a distance by the window being shown in the information carrier. When an interested viewer moves towards the showcase, the motion sensor then causes the computer to display on the display device for example an invitation for interactive operation thereof.

It will be appreciated that the invention is not limited to a showcase with one display wall. It also embraces design configurations of flat showcases having two oppositely disposed display walls and cases in the form of three-sided, four-sided or multi-sided prisms with a corresponding number of display walls. In that respect it is possible for individual ones of the display walls to be of a conventional design configuration while one or more others may be provided with a window, a display device and a computer for interactive control by the viewer, in accordance with the invention.

In regard to the display wall according to the invention for an information carrier such as a bill, poster, placard or the like, the display wall can be illuminated from the front and/or from the back, and in its image surface has a display device for digital picture or video signals, the display of which can be interactively controlled by a person viewing same. As noted above the display device can be for example a flat display screen which is integrated into the image surface of the display wall. Such a display wall is also suitable for example for mounting to an illuminatable window or to a wall. Such a display wall combines the advantages of an optionally illuminated and optionally interchangeable poster with an interactive display device. It permits optimum integration into sales areas, public spaces, at fairs and exhibitions and so forth.

Further objects, features and advantages of the invention will be apparent from the description hereinafter of a preferred embodiment.

### BRIEF DESCRIPTION OF THE DRAWING

FIG. 1 is an isometric exploded view of a showcase in accordance with the invention.

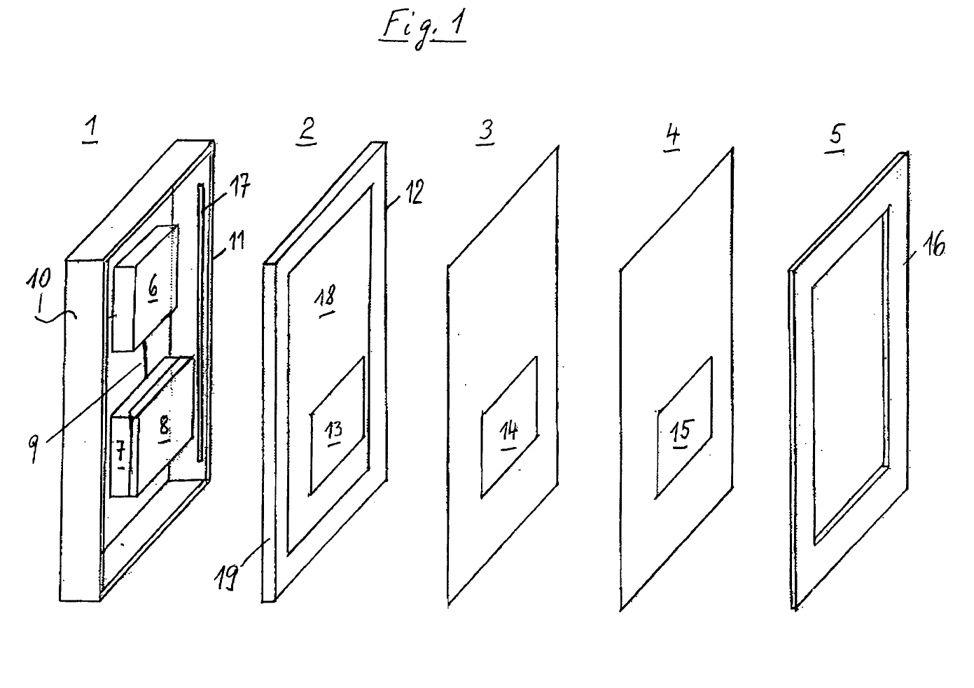

### DESCRIPTION OF THE PREFERRED EMBODIMENT

Looking at the drawing, the showcase according to the invention comprises a parallelepipedic body generally identified by reference numeral 1 which in its interior accommodates a computer diagrammatically indicated at 6 and a flat picture screen 8, for example a touch screen, on a support base 7. The showcase body 1 comprises a suitable material such as aluminum. Its dimensions are typically for example 680×930×80 mm so that this size of showcase is suitable for the DIN Al format. The computer 6 is supported on the rear wall of the body 1 and is supplied with information signals from the exterior by way of a cable indicated at 10. The computer 6 produces digital picture and video signals which are delivered by way of a line 9 to the touch screen 8 carried on the support base 7. Suitable lamps such as fluorescent tubes of which one is indicated at 17 are mounted for example to the inside of the vertical longitudinal walls of the body 1. Suitable power supply cables for the computer and the fluorescent tubes are provided but are not shown here for the sake of simplicity of the drawing.

The showcase further includes a rectangular show wall or display wall indicated generally at 2 comprising a light-conducting acrylic glass panel 18 in an aluminum frame 19. The frame 19 is mounted at a side edge 12 thereof to a side edge 11 of the body 1 in such a way that it can be pivoted open, for example in an upward direction, by means of a suitable hinge. The showcase may also include a gas spring for supporting the display wall 2 in the opened condition thereof.

Reference numeral 13 indicates a window which is cut out in the lower region of the panel 18 and which is congruent with the touch screen 8 when the display wall 2 is in the closed condition on the body 1 of the showcase.

Reference 3 generally denotes a suitable information carrier such as a bill, poster, placard or the like, which is placed on the display wall 2 and which also has a cut-out 14 congruent with the display screen 8. Reference 4 denotes a protective plate, for example of clear plastic material, which is placed over the poster 3 to provide protection for same relative to the exterior. The protective plate 4 also has a cut-out 15 in its lower region, which is congruent with the picture screen 8.

Finally reference numeral 5 denotes a holding frame which is preferably removable from the rest of the assembly and which extends around the outer edge of the showcase. The holding frame 5 makes it possible for the information carrier to be clamped in position between itself and the display wall 2 of the showcase, and thus interchangeably secured in position there. The holding frame 5 can also be pivotably mounted at a side edge 16 to a side edge of the assembly, for example a side edge of the display wall 2, for example by suitable hinges. The holding frame 5 can also be mounted to the remainder of the showcase at an upper edge thereof so that it is pivotable upwardly, in which case it can be suitably held in its raised position for example by a gas spring.

It will be noted from the foregoing description that an advantage of the showcase according to the invention is that the information represented on the display device can be easily modified. That can be implemented for example by altering the information stored in the storage means, and that can be effected by direct access thereto after the showcase has been opened or also by wireless information communication. In that way it is possible to take account in a simple manner of minor modifications, for example in respect of color, shape or price of products, in order to remain up-to-date in that respect.

It will be appreciated that the showcase according to the invention not only makes it possible to show a product or a service, but also to represent advantages and detail properties thereof on a product advice platform. In that respect the option of interactive operation is particularly suited to arousing interest on the part of a potential customer.

It will be appreciated that the above-described embodiment of the showcase and the display wall according to the present invention has been set forth solely by way of example and illustration thereof and that various other modifications and alterations may be made therein without thereby departing from the spirit and scope of the invention.

What is claimed is:

1. A showcase comprising
at least one display wall having a window,
a display device for displaying digital visual display signals, the display device being visible through said window, and
a signal source for generating said digital display signals and controllable by a person viewing the showcase.

2. A showcase as set forth in claim 1
wherein the display signals are digital picture signals.

3. A showcase as set forth in claim 1
wherein the display signals are digital video signals.

4. A showcase as set forth in claim 1
wherein the display device is a touch-sensitive screen.

5. A showcase as set forth in claim 1 and further including
means for generating acoustic signals.

6. A showcase as set forth in claim 1 and further including
means for reproducing acoustic signals.

7. A showcase as set forth in claim 1
wherein the display wall includes a removable holding frame adapted to hold an information carrier in position.

8. A showcase as set forth in claim 7
wherein said holding frame is mounted pivotably to a side edge.

9. A showcase as set forth in claim 1 including
means mounting the display wall pivotably to a side edge of the showcase.

10. A showcase as set forth in claim 1 and further including
means for backlighting of the display wall.

11. A showcase as set forth in claim 1 and further including
storage means for supplying the signal source with information.

12. A showcase as set forth in claim 1 and further including
means for receiving signals for supplying the computer with information.

13. A showcase as set forth in claim 12
wherein said means for receiving signals are wireless means.

14. A showcase as set forth in claim 12
wherein said means for receiving signals are wired means.

15. A showcase as set forth in claim 11
wherein said storage means is a digital non-volatile memory.

16. A showcase as set forth in claim 1
wherein said window occupies a proportion of between 5 and 25% of the surface area of the display wall.

17. A showcase as set forth in claim 1 and further including
means for identification of a person viewing same.

18. A showcase as set forth in claim 1 and further including
a motion sensor for controlling the signal source. .

19. A display wall for showing a flat information carrier, including
an image surface, and
in said image surface a display device for digital visual display signals, said display device being adapted to be controllable by a person viewing same.
